(19) United States
(12) Patent Application Publication
(10) Pub. No.: US 2009/0210904 A1
(43) Pub. Date: Aug. 20, 2009

(54) Control Of Multimedia Content Delivery

(76) Inventors: Samuel Pierce Baron, Santa Cruz, CA (US); Itzik George Cohen, Santa Cruz, CA (US)

Correspondence Address: Ashok Tankha, 36 Greenleigh Drive, Sewell, NJ, 08080, US

(21) Appl. No.: 12/371,580

(22) Filed: Feb. 14, 2009

Related U.S. Application Data
(60) Provisional application No. 61/028,516, filed on Feb. 14, 2008.

(51) Int. Cl. H04N 5/445

(52) U.S. Cl. 725/39

(57) ABSTRACT

Disclosed herein is a computer implemented method and system for controlling delivery of multimedia content. A multimedia control console is provided to console operator for controlling the multimedia content. The multimedia content is acquired from providers, for example, presenters or performers. The acquired multimedia content is listed on the multimedia control console. The multimedia content is selected for the delivery from the list based on predetermined criteria, for example, context of end user activity, end user behavior, and time and schedule of events. The selected multimedia content is then managed in the multimedia control console to suit end user requirement. The managed multimedia content is then delivered for real-time broadcasting to one or more end users. The multimedia control console therefore enables the control of the delivery of the multimedia content.

### CROSS REFERENCE TO RELATED APPLICATIONS

This application claims the benefit of provisional patent application No. 61/028,516 titled “Control Of Multimedia Content Delivery”, filed on Feb. 14, 2008 in the United States Patent and Trademark Office.

### BACKGROUND

This invention, in general, relates to multimedia content delivery. More particularly, this invention relates to controlling delivery of the multimedia content for broadcasting in real time or pre recorded by providers for broadcast to one or more end users.

Typically, bulk multimedia content such as audio content or video content are broadcasted to an end user on the internet. The multimedia content broadcasted to the end user is sometimes irrelevant, misdirected, or nonfunctional. Therefore, in order to monitor the verity and quality of the multimedia content, an application interface is required for controlling the multimedia content to be broadcasted. In order to provide improved quality of real-time broadcasting, there is a need to preview, prioritize or remove the multimedia content to be broadcasted. Moreover, regulation of multimedia content components such as volume of the audio content or the video content or title given to the multimedia content is required to improve the quality of real-time broadcasting.

Typically, the multimedia content is broadcast to end users in a context that does not enable user participation and social interaction. There is a need for a console that would enable the production of broadcast programming and real-time events with a social context, via real-time management of media and user interaction. There is also a need for a console that enables production of multimedia content broadcasts within a group-interactive context. Furthermore, there is a need for a “real-time” management of multimedia content and the synchronous consumption of content by one or more end users. There is also a need for managing multimedia content based on the context of interaction between end users and automating the production of the multimedia content broadcasted to the end users.

Therefore, there is a need for a computer implemented method and a system that controls delivery of the multimedia content and enables quality real-time broadcasting and management of the multimedia content to the end users.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for “real-time” management of multimedia content with a social context, via real-time management of media and user interaction, and automating the production of the multimedia content. A multimedia control console is provided for controlling the multimedia content. The multimedia control console enables management of multimedia content manually by one or more console operators. The functionality of the multimedia control console is divided between different console operators operating synchronously or asynchronously. The multimedia control console also enables the automated management of the multimedia content. The multimedia control console also enables a console operator to manually monitor and control the multimedia content delivery. Controlling of the multimedia content is also based on a hybrid of manual control and automated management, where the automated management is based on a set of business rules.

Multimedia content is acquired from multiple providers, for example, presenters, sponsors, end users or performers. The multimedia content comprises one of audio content, video content, text content, image content, and any combination thereof. The acquired multimedia content is listed on the multimedia control console. Additional multimedia content can be added manually to the list via the multimedia control console.

The multimedia content is selected for the delivery from the list based on predetermined criteria. The predetermined criteria for selection of multimedia content comprises, for example, one or more of context of end user activity, end user behavior, and time and schedule of events. The selected multimedia content is then managed and edited to suit user requirements. The multimedia control console enables automated management of the multimedia content. The automation is based on the set of business rules entered via the multimedia control console or by programming in an application programming interface. The business rules for example, comprise queuing the multimedia content and activity transitions according to an itinerary of events, where the multimedia content is queued based on either a timed schedule. Also, for example, the multimedia content is queued within a hybrid of manual control and automated management, where manual action by the console operator triggers a set of automated changes. Furthermore, for example, a poll is also set to appear automatically at a particular time code in the video content. The video content can be determined by user action, where user action for example comprises frequency and the type of interaction.

The multimedia content is managed in the multimedia control console. The console operator monitors the audio content in the multimedia control console. During monitoring of the audio content, the console operator accesses one or a combination of the audio content, adjusts equalization parameters of the audio content, and broadcasts the audio content to an end user interface. In one embodiment of the content delivery, the multimedia content is transmitted to a broadcast system, which in turn multiplexes the incoming multimedia content and broadcasts the multimedia content to the end user interface.

The multimedia control console provides a host of functions enabling management of the multimedia content. For example, the console operator conducts and manages an opinion poll on the multimedia control console. The console operator first creates a poll using a polling management interface in the multimedia control console. The created poll is displayed on the multi-functional display on an end user interface of one or more end users. Opinions are acquired to the created poll from one or more end users, and a result is determined. In one embodiment, the result is broadcasted directly to the end user interface. In a second example, the console operator creates a question using a user input management interface in the multimedia control console. The created question is displayed on an end user interface of one or more end users. Responses are acquired to the created question from one or more end users and transmitted to a broadcast system for broadcast to one or more end users. In a third example, the console operator obtains graphics content using a graphics management interface in the multimedia control console. The obtained graphics content is displayed on an end user interface of one or more end users. The obtained graphics is stored and transmitted to a broadcast system for broadcast to one or more end users. The managed multimedia content is then delivered for real-time broadcasting to one or more end users at predetermined intervals of time.

The console operator also previews the multimedia content in a preview window in the multimedia control. To broadcast the multimedia content in the list, multimedia content is selected from the list. The previewed multimedia content can also be cued in a cue window of the multimedia control console. The multimedia control console enables manual cueing of the multimedia content by selecting the multimedia content in the list of available multimedia. More than one of the multimedia content listed on the multimedia control console can be cued at the same time. The cued multimedia content is then transmitted for real-time broadcast on a live window. The cued multimedia content is then transmitted to the end user at predetermined intervals of time in the event of delivering the multimedia content. The multimedia content can further be removed from the list, the preview, the cue or the live broadcast window in the end user interface. The transmitted multimedia content is displayed on an end user interface.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of controlling delivery of multimedia content.

FIG. 2 exemplarily illustrates the audio-video workflows in the computer implemented system for controlling delivery of multimedia content.

FIG. 3 illustrates a computer implemented system for controlling delivery of multimedia content.

FIG. 4 illustrates a content management module comprising a console mixer for managing audio content.

FIG. 5 exemplarily illustrates components of a polling management interface of the multimedia control console for managing opinion polls.

FIG. 6 exemplarily illustrates components of a user input management interface of the multimedia control console for managing inputs of one or more end users.

FIG. 7 exemplarily illustrates components of a graphics management interface of the multimedia control console for managing graphics content obtained from one or more end users.

FIG. 8 exemplarily illustrates one embodiment of the multimedia control console.

FIG. 9 exemplarily illustrates a console mixer for managing audio content.

FIG. 10 exemplarily illustrates a screenshot of the polling management interface for managing opinion polls.

FIG. 11 exemplarily illustrates a screenshot of the user input management interface for managing inputs of one or more end users.

FIG. 12 exemplarily illustrates a screenshot of the graphics management interface for managing graphics content.

FIG. 13 exemplarily illustrates a screenshot of an end user interface.

### DETAILED DESCRIPTION OF THE INVENTION

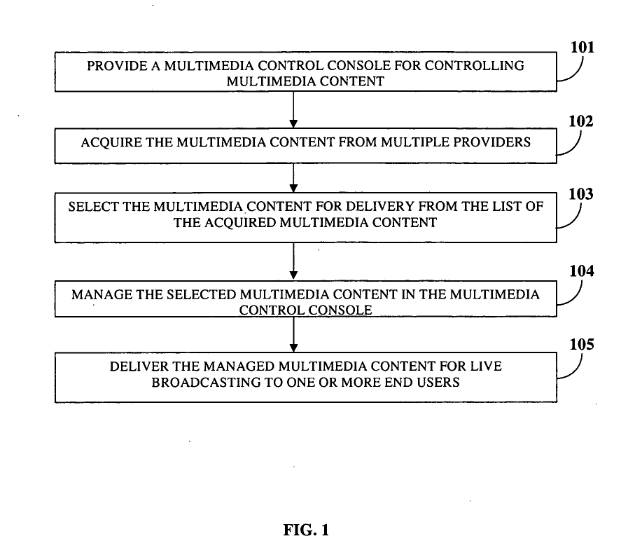

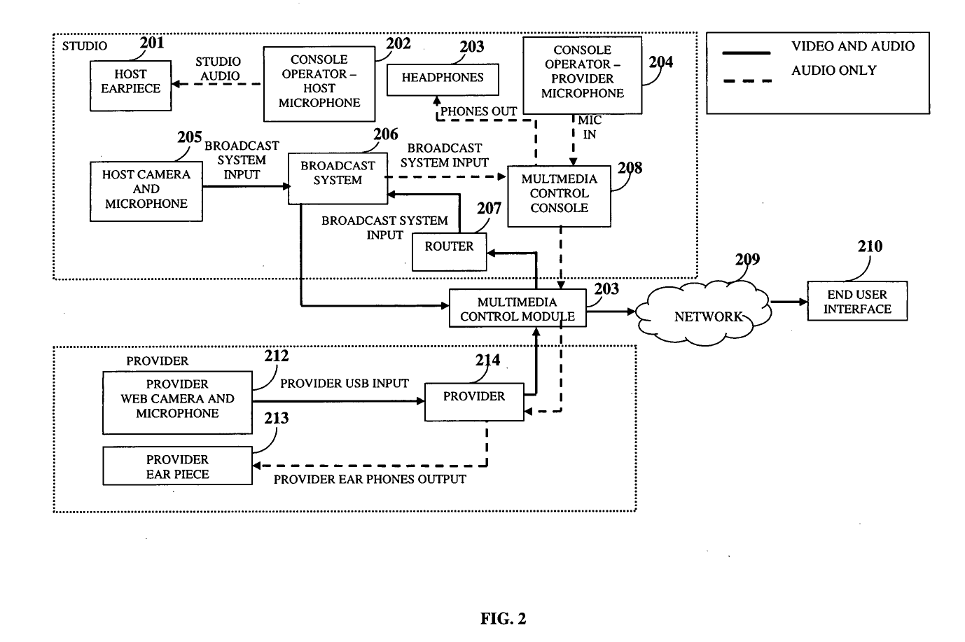

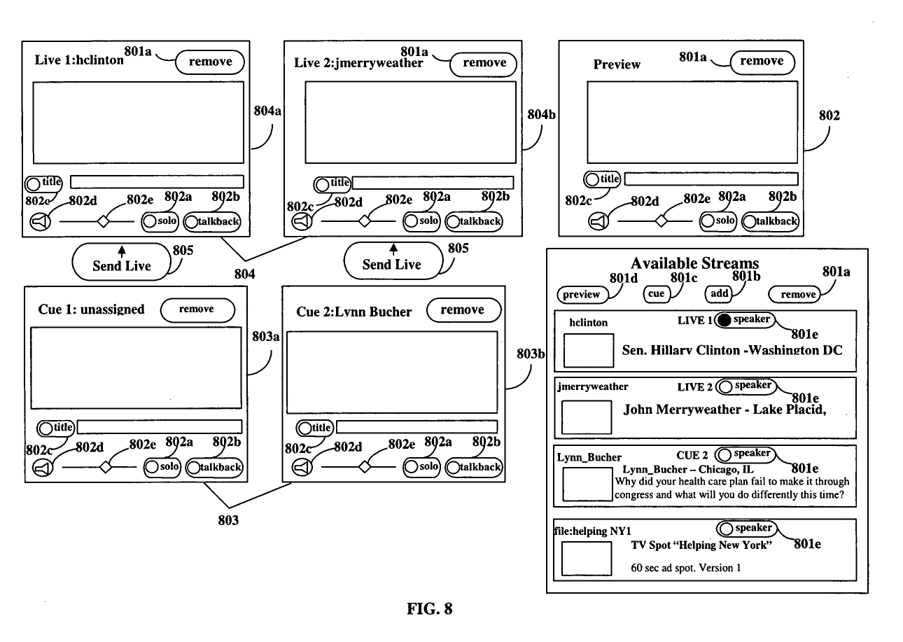

FIG. 1 illustrates a computer implemented method of controlling delivery of multimedia content to an individual, a group of viewers or a live audience herein referred to as an “end user”. A multimedia control console 208, as illustrated in FIG. 8, is provided 101 for controlling the multimedia content. The multimedia content delivery is automated using the multimedia control console 208. A console operator 301 also monitors and controls the multimedia content delivery manually using the multimedia control console 208. The multimedia content comprises one of audio content, video content, text content, image content, and any combination thereof. The audio content, for example, comprises music track or audio messages in a computer readable format. The video content, for example, comprises any electronically captured sequence of images representing scenes in motion stored as a computer readable format. The video content and audio content, for example, also comprises live audio and video streams. The multimedia content can also be a combination of audio content and text content or an audio content with a graphic content such as still images. The multimedia content is acquired from presenters, sponsors or performers, or end users herein referred to as “providers 214” in real time. Pre-recorded multimedia content can also be acquired from the providers 214. The providers 214 supply the multimedia content via a provider interface 304 as illustrated in FIG. 2.

The acquired multimedia content is listed on the multimedia control console 208. The list of available multimedia content acquired from the providers 214 is displayed on the multimedia control console 208. For example, the list of the available multimedia content is displayed as “Available Streams” on the multimedia control console 208 as illustrated in FIG. 8. The “Available Streams” section on the multimedia control console 208 depicts usernames or filenames of the multimedia content and thumbnail images of each of the multimedia content. For real time multimedia content, the thumbnail images are periodic image grabs from the multimedia content or thumbnail streaming video. For recorded multimedia content, the thumbnail images are the file thumbnail images of the multimedia content. The multimedia content can also be added to the list of available multimedia content manually. For example, the console operator 301 clicks on the “add” button 801b provided on the “Available Streams” section to add additional multimedia content to the list.

The multimedia content can be automatically selected from the list of the acquired multimedia content for the delivery. The automated selection 103 of the multimedia content is based on predetermined criteria. The predetermined criteria are, for example, context of end user activity, end user behavior, and time and schedule of events or a combination thereof. Consider an example where the providers 214 and the end user are involved in a real time virtual game. During the game session, the multimedia content is automatically selected 103 for real-time broadcast at specific times based on the rules of the game. In another example, where the providers 214 and the end user participate in an informative discussion forum, the multimedia content is selected based on input and response from the providers 214 or the end user. For real-time broadcasting, for example, in cable television, the selection 103 is performed based on the time stated for delivery of the multimedia content. Also, in another example, one or more console operators 301 manually select 103 the multimedia content for delivery.

The selected multimedia content in the multimedia control console 208 is edited and managed 104 before broadcasting. Managing the selected multimedia content, for example, comprises changing the audio, video, text or graphic properties of the multimedia content. Managing the selected multimedia content also comprises filtering end user gestures, for example, laughing, and filtering profanity. Managing further comprises the process of preparing language, images, sound, video, or film through correction, condensation, organization, and other modifications in various media. When the multimedia content is made up of audio content, the multimedia control console 208 manages the start time, stop time, and duration of any sound on the audio timeline. The multimedia control console 208 edits the properties of the audio content by fading into or out of an audio content. When the multimedia content is video content the video content is editing by re-arranging or modifying segments of video. For the console operator 301 removes unwanted sections, or parts of video, and arrange the different parts in time to synthesize an edited video. The multimedia control console 208 enables automated management of the multimedia content. The automation is based on a set of business rules entered via the multimedia control console 208 or by programming in an application programming interface. The multimedia content is also controlled manually by one or more console operators 301. The functionality of the multimedia control console 208 is divided between different console operators 301 operating synchronously or asynchronously. Controlling of the multimedia content is also based on a hybrid of manual control and automated management, where the automated management is based on the set of business rules entered via the multimedia control console 208.

The audio content is managed and prepared to be transmitted for broadcasting at the correct time. The console operator 301 monitors the audio content in the multimedia control console 208. The console operator 301 uses headphones 203 connected to the multimedia control console 208 to monitor the audio content. The multimedia control console 208 enables communication between a console operator 301 of the multimedia control console 208 and one or more of the providers 214. The console operator 301 communicates with the providers 214 on the multimedia control console 208 using a “talkback” 802b microphone and speaker 802d on the multimedia control console 208. Pressing the “talkback” button 802b sends a talkback microphone audio to the providers 214. Talkback can be selected for any number of providers 214.

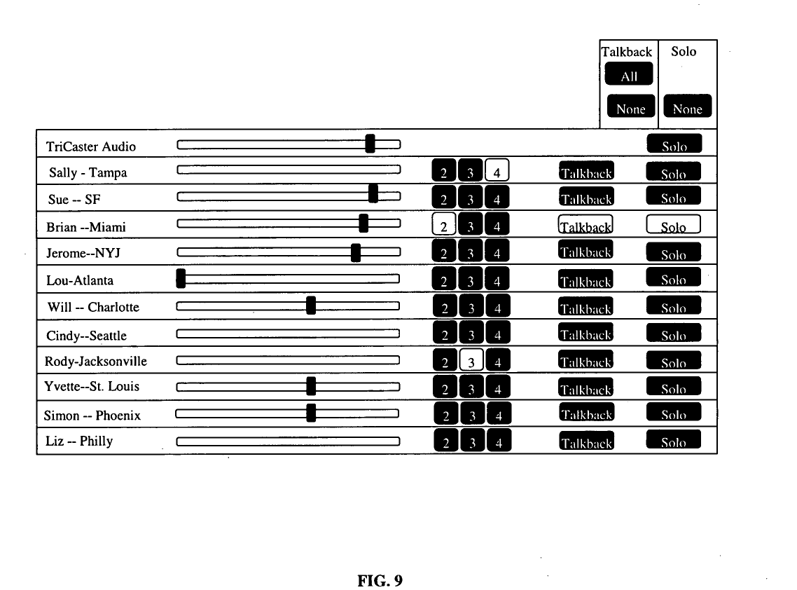

The multimedia control console 208 provides a host of functions enabling management of the multimedia content. For example, the multimedia control console 208 enables the console operator 301 to adjust equalization parameters of the audio content. The equalization parameters can comprise volume, frequency, etc. For example the console operator 301 uses a console mixer 401 to manage audio content as exemplarily illustrated in FIG. 9. The console mixer 401 comprises a volume control slider bar to adjust the volume of the multimedia content. The console operator 301 slides the slider bar in one direction to increase the volume of the audio content as exemplarily illustrated in FIG. 8. The console operator 301 slides the slider bar in the opposite direction to decrease the volume of the audio content. The console mixer 401 comprises an “All” button and a “None” button at the top of the talkback column in the console mixer 401. Selecting the “All” button enables talkback for all the providers 214 and selecting the “None” disables talkback for all providers 214 as exemplarily illustrated in FIG. 9.

The multimedia control console 208 also enables to the console operator 301 to access one or a combination of the audio content provided by one or more of the providers 214. The console mixer 401 also comprises a “solo” button as exemplarily illustrated in FIG. 9. Selecting the “solo” button engages the “solo mode”. The solo mode, allows the console operator 301 to “solo” or audition the audio content from the provider selected from the list. Pressing the “solo” button mutes the audio for all providers 214 who are not in the solo mode, for example in a live news studio situation where the console operator 301 needs to listen to one of the two presenters the console operator 301 will select the solo button corresponding to the presenter he wants to listen to. The console operator 301 now hears the audio content from only the presenter selected in solo mode. The “solo” button can be selected for more than one provider. The console mixer 401 comprises a “None” button at the top of the console mixer 401 as exemplarily illustrated in FIG. 9. Selecting the “None” button disables the solo mode for all the providers 214. The solo mode serves as the preferred way to set input levels in the multimedia control console 208. The audio content is directly transmitted to an end user interface 210 of the one or more end users. Alternately, the audio content is first transmitted to a broadcast system 206 and the broadcast system 206 multiplexes audio content, video content; text content, etc. from the multimedia control console 208 to obtain a multiplexed multimedia content. The multiplexed multimedia content is then broadcasted to the end user interface 210.

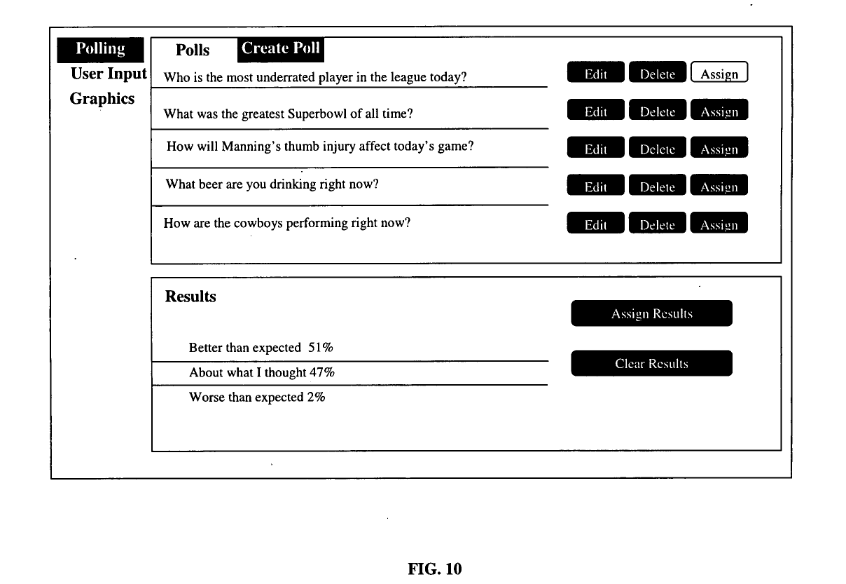

The multimedia control console 208 also enables management of the multimedia content such as opinion polls. The multimedia control console 208 enables the console operator 301 to conduct and manage an opinion poll. The console operator 301 of the multimedia control console 208 creates a poll using a polling management interface 302a in the multimedia control console 208. A screenshot of the polling management interface 302a for managing opinion polls is exemplarily illustrated in FIG. 10. The created poll is displayed on a multi-functional display 303 on the end user interface 210 of the one or more end users. Poll questions are pre-produced or authored during broadcast of the multimedia content. The console operator 301 creates a poll by selecting a “Create Poll” button on the polling management interface 302a as exemplarily illustrated in FIG. 10. The “Create Poll” button enables the console operator 301 to enter questions as in a text format. The created poll ranges in content based on the context of the end user activity, and end user behavior. The created poll for example is a question related to a game, where the console operator 301 creates a poll on coaching decisions, good call/bad call, player performance, next play to run, general: all-time greatest, rules changes, etc. The created poll is, for example, programming-related, where the console operator 301 for example creates a poll on what report should be heard from next, who should be interviewed after the game, vote for play of the day clips, etc. The polling management interface 302a enables the console operator 301 to solicit polling topics from the end users.

The console operator 301 selects answer options for the end user to select. The console operator 301 saves the question and the question is displayed on the question list at the top of the polling management interface 302a. The console operator 301 also edits the question by selecting the “Edit” button. The console operator 301 also deletes the question by selecting the “Delete” button. The console operator 301 selects the “Assign” button to broadcast and display a poll question on the end user interface 210. Opinions to the created poll are acquired from one or more end users. Voting in polls allows end users to participate by expressing themselves about any topic. A result of the created poll is determined based on the acquired opinions. The result is transmitted to a broadcast system 206 for broadcast to one or more end users. The console operator 301 selects the “Assign Results” button to display a poll results on the end user interface 210. The console operator 301 also clears the poll results by selecting the “Clear Results” button on the polling management interface 302a as exemplarily illustrated in FIG. 10.

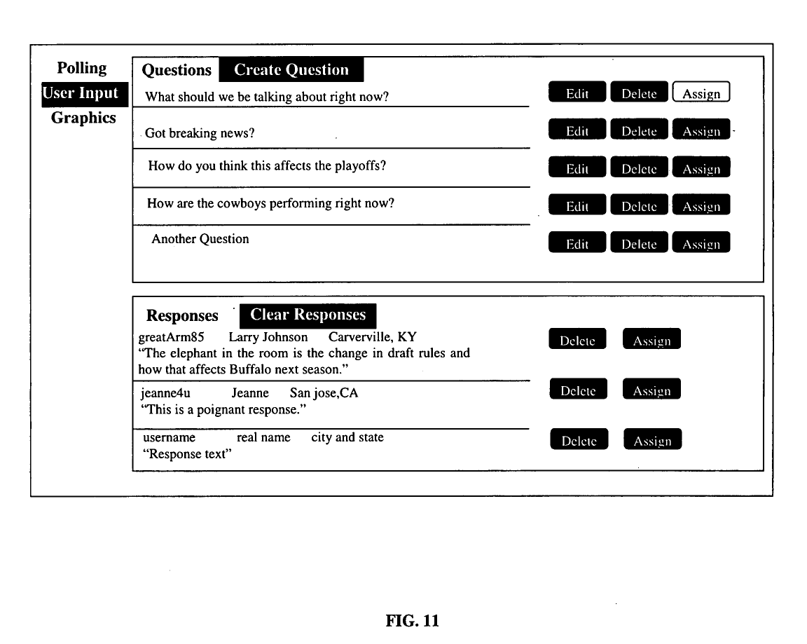

The multimedia control console 208 also enables management of the multimedia content such as user inputs. The multimedia control console 208 enables the console operator 301 to manage inputs from the end users. Management of the user input is performed on a user input management interface 302b in the multimedia control console 208. For example, the console operator 301 creates a question using the user input management interface 302b. A screenshot of the user input management interface for managing inputs of one or more end users is exemplarily illustrated in FIG. 11. The created question is displayed on a multi-functional display 303 on the end user interface 210 to the one or more end users.

The console operator 301 creates a question on the user input management interface 302b by selecting a “Create Question” button on the user input management interface 302b and entering a question in text format. The console operator 301 also edits the question by selecting the “Edit” button and changing the text of the question. The console operator 301 when required deletes the question by selecting the “Delete” button on the user input management interface 302b. The console operator 301 selects the “Assign” button to broadcast the question to the end users as illustrated by FIG. 11.

The console operator 301 acquires responses to the created question from the one or more end users. The responses are automatically recorded for each question. The console operator 301 selects a question from the list and the corresponding responses are displayed in the user input management interface 302b. In one embodiment, the acquired responses are directly broadcasted to the end user interface 210 of the one or more end users. In another embodiment, the acquired responses are transmitted to a broadcast system 206 for broadcast to one or more end users. The multimedia content is received by the broadcast system 206. The broadcast system 206 subsequently broadcasts the transmitted multimedia content to the multifunctional display 303 on the end user interface 210. The console operator 301 sends the responses to the end users by clicking the “Assign” button. When required the console operator 301 deletes responses in the user input management interface 302b by clicking the “Delete” button. Furthermore, the user input management interface 302b allows the console operator 301 to clear all acquired responses by clicking the “Clear Responses” button as illustrated in FIG. 11.

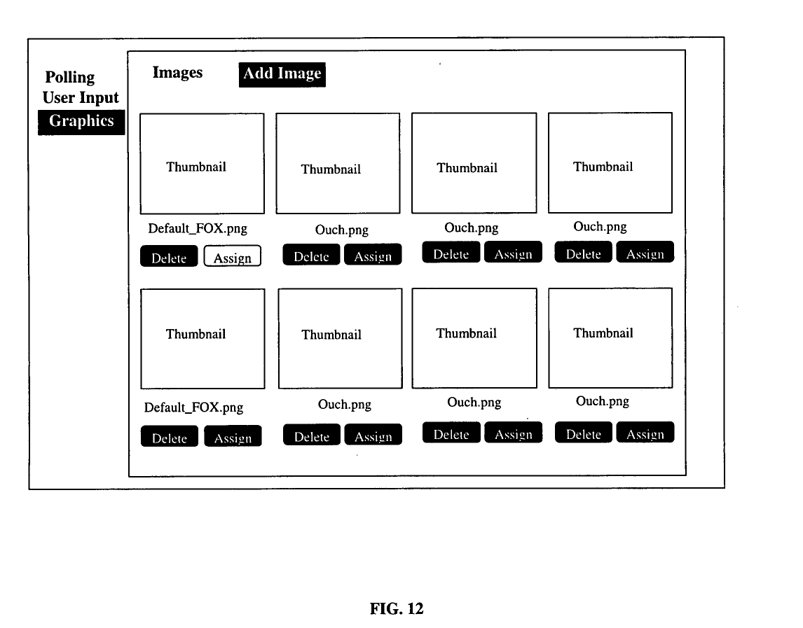

The multimedia control console 208 also enables management of the multimedia content such as graphics content. The multimedia control console 208 enables the console operator 301 to obtain and manage graphic content using a graphics management interface 302c in the multimedia control console 208. A screenshot of the graphics management interface 302c for managing graphics content is exemplarily illustrated in FIG. 12. The obtained graphics content is displayed on a multimedia control console 208. The obtained graphics is stored in the multimedia control console 208. In one embodiment, the stored graphics content is directly broadcasted to the end user interface 210 of the one or more end users. In another embodiment, the graphics content is transmitted to a broadcast system 206 for broadcast to one or more end users. The graphics content is received by the broadcast system 206. The broadcast system 206 subsequently broadcasts the transmitted graphics content to the multifunctional display 303 in the end user interface 210. The obtained graphics, for example, comprises promotions, advertisements, and announcements, etc. to be transmitted to the end users.

To add graphics content, in the graphics management interface 302c, for example, an image, the console operator 301 selects the “Add Image” button. The “Add Image” button allows the console operator 301 to select an image from a file on the network 209 and provides a field to add a click through URL. The image file in the format of jpg, png, gif, and bmp file types are supported. The obtained image content is then broadcasted and displayed on a multi-functional display 303 to the end users on the end user interface 210. The image is then stored on the network 209 to allow access to the end users. The stored image, for example, is displayed on the graphics management interface 208c as thumbnails images. The “Delete” button removes the image from the list as illustrated by FIG. 12. The “Assign” button assigns the graphic to a multi-functional display 303 on the end user interface 210. The end user clicks the graphic in the end user interface 303 to open the graphic's click through URL.

The console operator 301 selects the multimedia content and displays the selected multimedia content on the multimedia control console 208. The console operator 301 previews the list of available multimedia content in a preview window 802 of the multimedia control console 208 as exemplarily illustrated in FIG. 8. For example, a list of available multimedia content acquired from the providers 214 is displayed on the multimedia control console 208. For example, the list of the available multimedia content is displayed as “Available Streams” on the multimedia control console 208 as illustrated in FIG. 8. The multimedia content is also added to the list of available multimedia content manually. For example, the console operator 301 clicks on the “add” button 801b provided on the “Available Streams” section to add additional multimedia content to the list.

The multimedia content is selected from the “Available Streams” section 801 and a “preview” button 801d is clicked to preview the selected multimedia content. The selected multimedia content is then previewed on a “Preview” window 802 as illustrated in FIG. 8. One or more of the multimedia content in the list can be previewed at the same time. The console operator 301 also cues the previewed multimedia content in a “cue” window 803 on the multimedia control console 208. In one example, the previewed multimedia content is manually cued by selecting the multimedia content in the list of available multimedia content for cueing. For example, the console operator 301 selects the multimedia content from the “Available Streams” section for cueing and click on the “cue” button 801c to place the selected multimedia content in a cue on “Cue” windows 803 as illustrated in FIG. 8. The multimedia control console 208 allows one or more of the multimedia content to be cued at the same time. For example, a first multimedia content is cued in a “Cue1” window 803a and a second multimedia content is cued in a “Cue2” window 803b as illustrated in FIG. 8.

The multimedia control console 208 is also used for manually controlling multimedia content components such as a title given to the multimedia content, volume of the multimedia content or audio content of the multimedia content. For example, “title” button 802c on the “Preview” window 802, the “Cue” windows 803, and the “Live” windows 804 is clicked to activate or deactivate the display of the title of the multimedia content as illustrated in FIG. 8. The title is hidden from the end user when the title display is deactivated. The title is also edited by the console operator 301. Changing a title from a window also changes the title in the list of available multimedia content. Below the title a question the display comprises a caption, for example, “Why did your health care plan fail to make it through congress and what will you do differently this time?” for referencing during question and answer sessions.

The multimedia content can be removed manually from the list of available multimedia content, the preview, the cue, or the live broadcast. For example, the console operator 301 clicks the “remove” button 801a to remove the multimedia content from the “Available Streams” section 801, the “Preview” window 802, the “Cue” windows 803, and the “Live” windows 804. The “remove” button 801a renders the windows blank. The multimedia content removed from the “Preview” window 802, the “Cue” windows 803, and the “Live” windows 804 is made available in the “Available Streams” section 801. The multimedia content is only assigned to one window at a time. In one embodiment, the cued multimedia content is directly transmitted to an end user interface of one or more end users. In another embodiment, the cued multimedia content is transmitted to a broadcast system 206 for real-time broadcast to the end user. The transmitted multimedia content is displayed on the multi-functional display 303 in the end user interface 210.

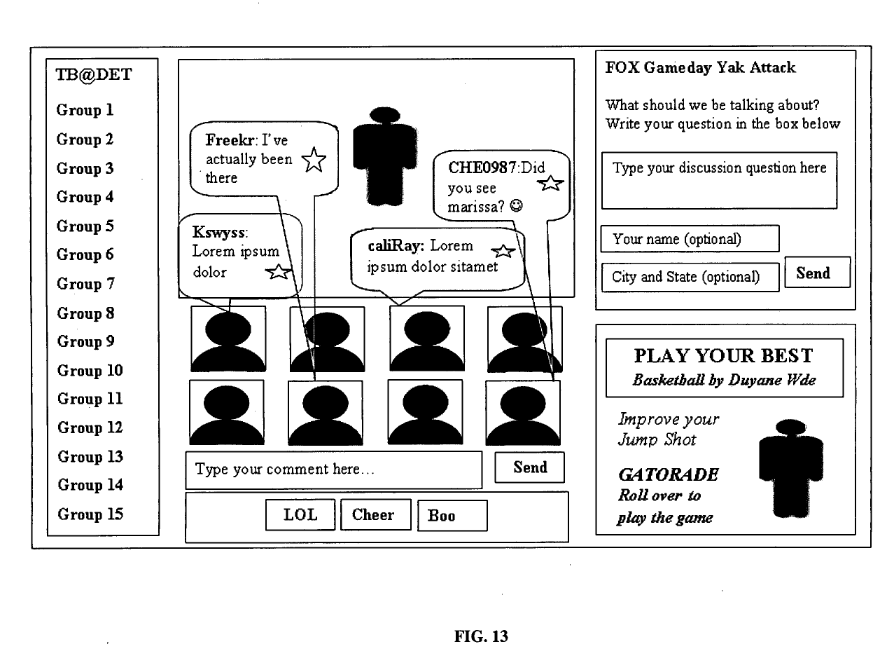

The multimedia console delivers 105 the managed multimedia content to the broadcast system 206 order to broadcast the multimedia content to one or more end users at an end user interface 210. The multimedia control console 208 allows the multimedia content to be manually delivered for real-time broadcast. For example, the console operator 301 selects the multimedia content placed in the cue 803 and clicks on the “Send Live” button 805 on the multimedia control console 208. On clicking the “Send Live” button 805, the selected multimedia content is broadcasted in “Live” window 804. The multimedia content in the “Live” windows 804 appears on a corresponding window of a video display component of the end user interface 210. The multimedia content is delivered to the end user at predetermined intervals of time in the event of delivering the multimedia content. The end user views the live broadcast in a multi-functional display an end user interface 210 as illustrated in FIG. 13.

The multimedia control console 208 allows the console operator 301 to manually deliver the multimedia content for live broadcast. For example, the console operator 301 selects the multimedia content placed in the cue and clicks on the “Send Live” button 805 provided above the “Cue” windows 804 on the multimedia control console 208. On clicking the “Send Live” button 805, the selected multimedia content is broadcasted in “Live” windows 804 as illustrated in FIG. 8. The multimedia content in the “Live” windows 804 appears on a corresponding window of a video display component of the end user. One or more of the multimedia content in the cue is broadcasted to the end user. For example, a first multimedia content is broadcasted in a “Live1” 804a window and a second multimedia content in a “Live2” 804b window as illustrated in FIG. 8. The multimedia content is delivered to the end user at predetermined intervals of time in the event of delivering the multimedia content. The end user views the real-time broadcast via an end user interface 210.

A “Solo” button 802a is provided on the “Preview” window 208; the “Cue” windows 803 and the “Live” windows 804 to enable the console operator 301 to hear only the audio of the multimedia content. More than one of the multimedia content can be selected and heard at the same time. The console operator 301 can speak to an individual provider through the multimedia control console 208. For example, the console operator 301 clicks on the “talkback” button 801b provided on each of the “Preview” window 801; the “Cue” windows 808, and the “Live” windows 804 as illustrated in FIG. 8 to sends the audio from the microphone of the console operator 301 to the providers 214. Activating “talkback” for the multimedia content deactivates any “talkback” on other multimedia content. In order to activate “talkback” simultaneously for each of the multimedia content, the console operator 301 presses a “Shift” button on a keyboard of console operator's 301 computing device while clicking the “talkback” button 801b for each of the multimedia content. In order to deactivate “talkback”, the console operator 301 presses the “Shift” button on the keyboard while clicking the “talkback” button 801b for the multimedia content already in “talkback” mode. In case of deactivating “talkback” for one of the multimedia content, the other multimedia content still remains activated for “talkback”. The “talkback” button 801b can be hidden or disabled for recorded multimedia content. A “speaker” button 801e is incorporated for each of the multimedia content in the “Available Streams” section 801 to act as a teleprompter to the providers 214.

Playback controls such as play or pause, seek scrubber, and running time can be provided in preview, cue and live broadcast for pre recorded multimedia content. When the recorded multimedia content is reassigned between preview, cue, or live, the play head position is retained. Playback begins automatically when recorded multimedia content is sent live.

FIG. 2 exemplarily illustrates the audio and video workflows in the computer implemented system for controlling delivery of multimedia content. Consider an example of an interview being conducted in a studio by a host, wherein a console operator 301 produces the show. One or more remote providers 214 from different locations also provide live and pre-recorded multimedia content to the console operator 301 of the multimedia control console 208. The providers 214 are each provided with a provider ear piece 213 connected to the multimedia control console 208, a provider web camera and microphone 212 to communicate with the multimedia control module 211. The console operator 301 is provided with headphones 203 connected to the multimedia control console 208, console operator-host microphone 202 to communicate with the host, and a console operator-provider microphone 204 to communicate with the providers 214. The host is provided with a host ear piece 201 connected to the multimedia control console 208, a web camera and a microphone 205 to communicate with the console operator 20. The provider earpiece 213 enables the provider 214 to hear any inputs being sent by the console operator 301. The console operator 301 hears audio inputs from the multimedia control console 208 via the headphones 203. The input from the console operator microphone 203 is sent as input to the multimedia control console 208. The input from the host is captured by an in-studio host camera and microphone 205, and is transmitted to the broadcast system 206 video input and the broadcast system 206 audio input. In this example, the input from the host is captured by an in-studio host camera and microphone 205, and this input is directly broadcasted to the end users.

The console operator 301 and host are in the same studio and therefore the console operator 301 is able to talk back to the host via the in-studio talkback system, from a dedicated microphone to the host's earpiece 201. Each provider sends multimedia content which is captured by a webcam and microphone 212 at a remote location away from the studio. The provider webcam and microphone 212 are connected to a remote computer. The remote computer user transmits the multimedia content to the multimedia control console 208, which in turn transmits the multimedia content to a computer in the studio called the “router” 207 as illustrated in FIG. 2. The router 207 converts the multimedia content to a component video output and a separate audio output. The multimedia content output from the computer's video card is sent to the broadcast system 206 video and audio inputs. Each provider 214 requires a separate video card, necessitating either multiple remote routing computers or multiple video cards in a single router 207.

Using the broadcast client 307, the console operator 301 creates real-time multimedia content from the host content, provider content, recorded content, graphics content, etc. The program is streamed from the broadcast system 206 to the multimedia control console 208, which routes the content to the multimedia control console 208 for distribution via a network 209 to end users. The program video is displayed in the end user interface 210 in a video window as illustrated in FIG. 13. The end user interface 210 is a web service that enables the end user to access the streaming multimedia content and participate in the show. The web service is instantiated via an embedded code in the web service. The web service handles login, and requires the user to login in order to load the user interface. For unregistered users, the page also allows the user to create a temporary username. One example of the end user interface 210 is illustrated in FIG. 13 and comprises a video window to display video content, a multi-functional display 303 on the top right hand side of the end user interface 210, an advertising window on the right bottom of the screen, a list of available groups an end user can join. The web service further comprises a user participation window below the video window, where the users can add comments and communicate with other users as illustrated in FIG. 13.

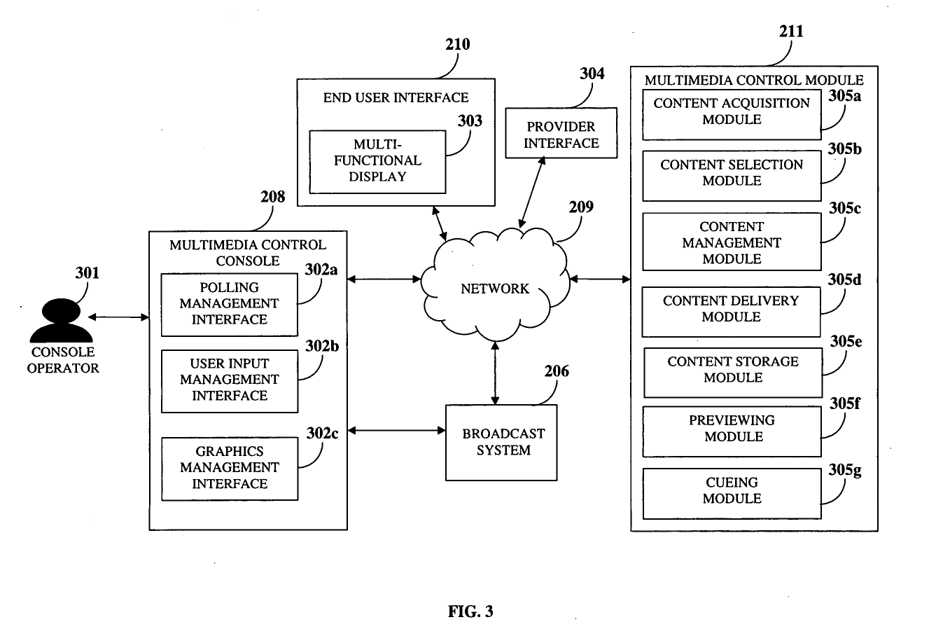

FIG. 3 illustrates a computer implemented system for controlling the delivery of multimedia content from providers 214 to end users. The computer implemented system disclosed herein comprises a multimedia control console 208, a provider interface 304, an end user interface 210, a broadcast system 206, and a multimedia control module 211 connected via a network 209.

A multimedia control console 208 controls the multimedia content. The multimedia control module 211 controls the delivery of the multimedia content. The multimedia control module 211 comprises a content acquisition module 305a, a content selection module 305b, a content management module 305c, a content delivery module 305d, and a content storage module 305e. The providers 214 supply the multimedia content via the provider interface 304. The content acquisition module 305a acquires multimedia content, for example, audio content, video content, text content, image content, and any combination thereof, from the providers 214. Multimedia content is acquired in real time or pre recorded multimedia content by the providers 214. The acquired multimedia content is listed on the multimedia control console 208. A list of available multimedia content is displayed on the multimedia control console 208. The content selection module 305b selects the multimedia content for delivery from the list of the acquired multimedia content based on predetermined criteria. The predetermined criteria, for example, comprise context of the end user activity, end user behavior, and time and schedule of events. The content management module 305c manages the selected multimedia content in the multimedia control console 208. The content management module 305c uses rules set by the console operator 301 to automate management of the multimedia content. In one example, multimedia content is manually managed by one or more console operators 301. In another example, controlling the multimedia content is also based on a hybrid of manual control and automated management, where the automated management is based on a set of business rules. The content delivery module 305d delivers the multimedia content for real-time broadcast to one or more end users at predetermined intervals of time. The end users view the real-time broadcast via an end user interface 210.

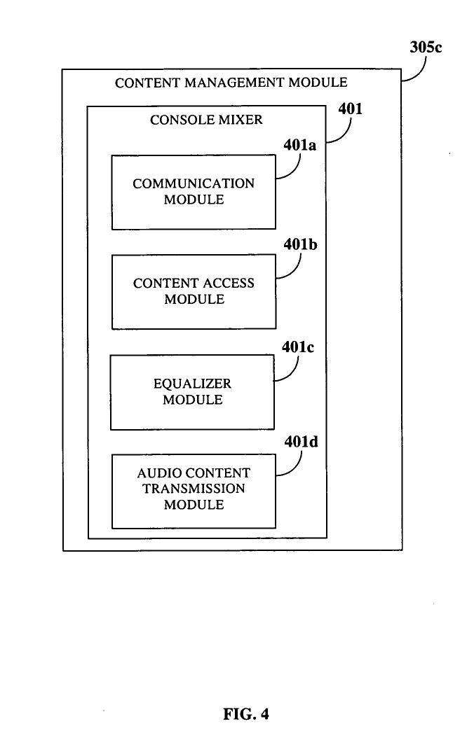

FIG. 4 illustrates a content management module 305c comprising a console mixer 401 for managing audio content. The content management module 305c comprises a console mixer 401 for monitoring audio content in the multimedia control console 208. The console mixer 401 comprises a communication module 401a, a content access module 401b, an equalizer module 401c, and an audio content transmission module 401d. The communication module 401a enables communication between a console operator 301 of the multimedia control console 208 and one or more of the providers 214. The content access module 401b enables the console operator 301 to access one or a combination of the audio content provided by one or more of the providers 214. The audio content transmission module 401d transmits the audio content directly to the end user interface 210. In another embodiment, the audio content transmission module 401d transmits the audio content to a broadcast system 206 for broadcast to one or more end users.

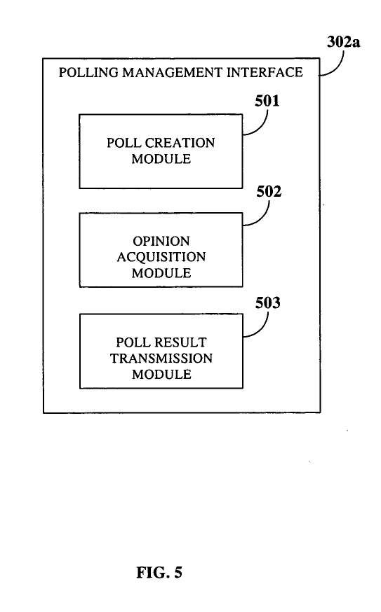

FIG. 5 exemplarily illustrates components of a polling management interface 302a of the multimedia control console 208 for managing opinion polls. The multimedia control console 208 further comprises a polling management interface 302a to manage opinion polls. The polling management interface 302a comprises a poll creation module 501, an opinion acquisition module 502, and a poll result transmission module 503. The poll creation module 501 enables the console operator 301 to conduct an opinion poll by creating a poll. The poll created by the console operator 301 is displayed on the multimedia control console 208. The created poll is then transmitted to the broadcast system 206 for broadcasting to one or more end users. The opinion acquisition module 502 acquires opinions to the created poll from one or more end users. The content management module 305c determines a result of the created poll based on the acquired opinions. In one embodiment, the poll result transmission module 503 transmits the result directly to the end user interface 210. In another embodiment, the poll result transmission module 503 transmits the result to a broadcast system 206 for broadcasting to the end users. The broadcasted multimedia content is displayed on a multi-functional display 303 in the end user interface 210.

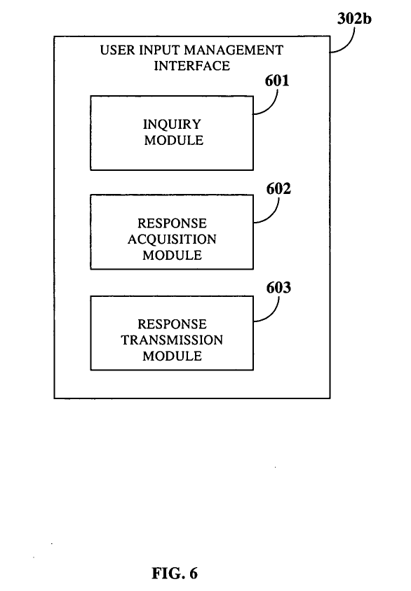

FIG. 6 exemplarily illustrates components of a user input management interface 208b of the multimedia control console 208 for managing inputs of one or more end users. The multimedia control console 208 further comprise a user input management interface 208b for managing inputs from one or more end users in the multimedia control console 208. The user input management interface 208b comprises an inquiry module 601, a response acquisition module 602, and a response transmission 603. The inquiry module 601 enables the console operator 301 to create a question. The created question is displayed on a multi-functional display 303 in the end user interface 210. The response acquisition module 602 acquires responses to the created question from one or more end users. The acquired responses to the created question are recorded. In one embodiment, the response transmission module 603 transmits the acquired responses directly to the end user interface 210. In another embodiment, the response transmission module 603 transmits the acquired responses to a broadcast system 206 for broadcast to one or more end users. The broadcasted multimedia content is displayed on a multi-functional display in the end user interface.

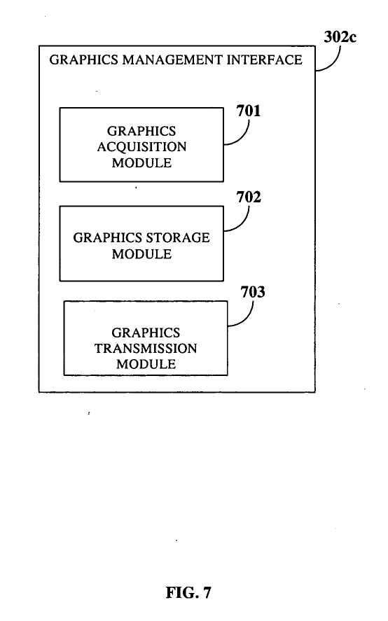

FIG. 7 exemplarily illustrates components of a graphics management interface of the multimedia control console 208 managing graphics content obtained from one or more end users. The multimedia control console 208 also comprises a graphics management interface 208c for managing graphics content. The graphics acquisition module 701 obtains the graphics content from the providers 214. The obtained graphics content is displayed in the multimedia control console 208. The graphics storage module 702 stores the obtained graphics content. In one embodiment, the graphics transmission module 703 transmits the graphics content directly to the end user interface 210. In another embodiment, the graphics transmission module 703 transmits the graphics content to a broadcast system 206 for broadcasting to one or more end users. The broadcasted graphics content is displayed on the multi-functional display in the end user interface.

The multimedia control console 208 comprises available streams lists, a preview windows, cue windows, and live windows as illustrated in FIG. 8. The multimedia control console 208 displays the created polls, the results, the user inputs, the obtained graphics, etc. The multimedia control module further comprises a previewing module 305f, a cueing module 305g, and a transmission module 403. The previewing module 305f enables the console operator 301 to previewing the multimedia content in a preview window 802. The cueing module 305g enables the console operator 301 to edit the previewed multimedia content and cued multimedia content in cue window 803. The content delivery module 305d transmits the multimedia content in the cued window 803 to a broadcast system 206 for real-time broadcast. The video component of the multimedia content is displayed on a video window in the end user interface 210, and text, polls and graphics content is displayed in the multi-functional display 303 in the end user interface 210 as illustrated in FIG. 13.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of controlling delivery of multimedia content, comprising the steps of:
providing a multimedia control console for controlling said multimedia content,
acquiring the multimedia content from a plurality of providers, wherein said acquired multimedia content is listed on said multimedia control console,
selecting the multimedia content for said delivery from said list of the acquired multimedia content based on predetermined criteria, wherein said predetermined criteria comprises one or more of context of end user activity, end user behavior, and time and schedule of events,
managing said selected multimedia content in the multimedia control console, and
delivering said managed multimedia content for real-time broadcasting to one or more end users at predetermined intervals of time,
whereby the multimedia control console enables said control of the delivery of the multimedia content.

2. The computer implemented method of claim 1, wherein the multimedia content comprises one of audio content, video content, text content, image content, and any combination thereof.

3. The computer implemented method of claim 1, wherein said step of managing the selected multimedia content comprises the step of monitoring audio content in the multimedia control console.

4. The computer implemented method of claim 3, wherein said step of monitoring said audio content comprises one or more of the steps of:
enabling communication between a console operator of the multimedia control console and one or more of providers and end users,
accessing one or a combination of the audio content provided by one or more of the providers,
adjusting equalization parameters of the audio content, and
transmitting the audio content to an end user interface of the one or more end users.

5. The computer implemented method of claim 1, wherein said step of managing the selected multimedia content comprises the step of creating a poll by a console operator of the multimedia control console using a polling management interface in the multimedia control console, wherein said created poll is displayed on a multi-functional display on an end user interface.

6. The computer implemented method of claim 5, further comprising the step of acquiring opinions to said created poll from the one or more end users.

7. The computer implemented method of claim 6, further comprising the step of determining a result of the created poll based on said acquired opinions, and transmitting said result to an end user interface of the one or more end users.

8. The computer implemented method of claim 1, wherein said step of managing the selected multimedia content comprises the step of creating a question by a console operator of the multimedia control console using a user input management interface in the multimedia control console, wherein said created question is displayed on a multi-functional display on an end user interface.

9. The computer implemented method of claim 8, further comprising the step of acquiring responses to said created question from the one or more end users.

10. The computer implemented method of claim 9, further comprising the step of recording said acquired responses to the created question and transmitting the acquired responses to an end user interface of the one or more end users.

11. The computer implemented method of claim 1, wherein said step of managing the selected multimedia content comprises the step of obtaining graphics content by a console operator of the multimedia control console using a graphics management interface in the multimedia control console, wherein said obtained graphics content is displayed on a multi-functional display on an end user interface.

12. The computer implemented method of claim 11, further comprising the step of storing said obtained graphics and transmitting said stored graphics to an end user interface of the one or more end users.

13. The computer implemented method of claim 1, further comprising the steps of:
previewing one or more of the multimedia content in a preview window in the multimedia control console by a console operator,
cueing said previewed multimedia content in a cue window in the multimedia control console, and
transmitting said cued multimedia content to a broadcast system for real-time broadcast on a live window in the multimedia control console, wherein said transmitted multimedia content is displayed on an end user interface.

14. A computer implemented system for controlling delivery of multimedia content, comprising:
a multimedia control console for enabling control of said delivery of said multimedia content,
a multimedia control module for controlling the delivery of the multimedia content, comprising:
a content acquisition module for acquiring the multimedia content from a plurality of providers, wherein said acquired multimedia content is listed on said multimedia control console,
a content selection module for selecting the multimedia content for the delivery from said list of the acquired multimedia content based on predetermined criteria, wherein said predetermined criteria comprises one or more of context of end user activity, end user behavior, and time and schedule of events,
a content management module for managing said selected multimedia content in the multimedia control console, and
a content delivery module for delivering said managed multimedia content for real-time broadcasting to one or more end users at predetermined intervals of time.

15. The computer implemented system of claim 14, wherein said multimedia control module further comprises a content storage module for storing the acquired multimedia content.

16. The computer implemented system of claim 14, wherein said content management module comprises:
a console mixer for monitoring audio content in the multimedia control console, wherein said console mixer comprises:
a communication module for enabling communication between a console operator of the multimedia control console and one or more of the providers and end users,
a content access module for accessing one or a combination of the audio content provided by one or more of the providers,
an equalizer module for adjusting equalization parameters of the audio content, and
an audio content transmission module for transmitting the audio content to a broadcast system for broadcast to the one or more end users.

17. The computer implemented system of claim 14, wherein the multimedia control console comprises a polling management interface, wherein said polling management interface comprises:
a poll creation module for creating a poll by a console operator of the multimedia control console, wherein said created poll is displayed on a multi-functional display on the end user interface,
an opinion acquisition module for acquiring opinions to said created poll from the one or more end users, and wherein said content management module determines a result of the created poll based on said acquired opinions, and
a poll result transmission module for transmitting said result to an end user interface of the one or more end users.

18. The computer implemented system of claim 14, wherein the multimedia control console comprises a user input management interface for managing inputs from the one or more end users, wherein said user input management interface comprises:
an inquiry module for creating a question by console operator of the multimedia control console, wherein said created question is displayed on a multi-functional display on the end user interface,
a response acquisition module for acquiring responses to the created question from the one or more end users, and
a response transmission module for transmitting the acquired responses to an end user interface of the one or more end users.

19. The computer implemented system of claim 14, wherein the multimedia control console comprises a graphics management interface, wherein said graphics management interface comprises:
a graphics acquisition module for obtaining graphics content by a console operator of the multimedia control console, wherein said obtained graphics content is displayed on a multi-functional display on the end user interface,
a graphics storage module for storing said obtained graphics content, and
a graphics transmission module for transmitting said stored graphics content to an end user interface of the one or more end users.

20. The computer implemented system of claim 14, wherein said content management module comprises:
a previewing module for previewing a multimedia content in a preview window in the multimedia control console, and
a cueing module for cueing said previewed multimedia content in a cue window in the multimedia control console.

21. A computer program product comprising computer executable instructions embodied in a computer-readable medium, wherein said computer program product comprises:
a first computer parsable program code for providing a multimedia control console for controlling multimedia content,
a second computer parsable program code for acquiring said multimedia content from a plurality of providers, wherein said acquired multimedia content is listed on said multimedia control console,
a third computer parsable program code for selecting the multimedia content for delivery from said list of the acquired multimedia content based on predetermined criteria, wherein said predetermined criteria comprises context of end user activity, end user behavior, and time and schedule of events,
a fourth computer parsable program code for managing said selected multimedia content in the multimedia control console, and
a fifth computer parsable program code for delivering said managed multimedia content for real-time broadcasting to one or more end users at predetermined intervals of time.
